(19) United States
(12) Patent Application Publication
(10) Pub. No.: US 2026/0015537 A1
(43) Pub. Date: Jan. 15, 2026

(54) ACID-HYDROLYZABLE RESIDUE-FREE DRILLING FLUID AND PREPARATION METHOD THEREOF

(71) Applicant: Yangtze University, Jingzhou (CN)

(72) Inventor: Fuchang You, Jingzhou (CN)

(21) Appl. No.: 18/976,282

(22) Filed: Dec. 10, 2024

(30) Foreign Application Priority Data
Jul. 9, 2024 (CN) 202410914150.7

(51) Int. Cl. C09K 8/12

(52) U.S. Cl. CPC C09K 8/12

(57) ABSTRACT

An acid-hydrolyzable residue-free drilling fluid includes the following components in parts by weight: 100 parts of water, 0.5-1.5 parts of a pH regulator, 0.5-1.0 parts of a flow pattern regulator, 1.0-4.0 parts of a filtrate reducer, 0-10.0 parts of a temporary plugging agent, 1.0-3.0 parts of an inhibitor and 5.0-200.0 parts of a weighting agent; the pH regulator is a mixture of sodium citrate, magnesium oxide and sodium carbonate; the flow pattern regulator includes at least one of polyethylene oxide and polyethyleneimine; and the filtrate reducer includes one or more selected from the group consisting of waxy starch, waxy physically modified starch and waxy chemically modified starch. The acid-hydrolyzable residue-free drilling fluid overcomes shortcomings of residue and non-degradation of drilling fluids without solid phases or clay phases in the related art, and can be dissolved by an acidic well completion fluid to form a transparent clear solution without suspended matter.

### TECHNICAL FIELD

The disclosure belongs to the technical field of drilling fluids for oil and gas reservoirs, in particular to an acid-hydrolyzable residue-free drilling fluid and a preparation method thereof.

### BACKGROUND

China's oil and gas exploration and development efforts have increased, and crude oil and natural gas production has continued to increase. Hydrocarbon reservoir protection is an important means to efficiently develop the oil and gas reservoirs. How to reduce a damage of the drilling fluids to the reservoirs is a prerequisite to ensure the oil and gas production.

The drilling fluids refer to drilling fluids for drilling the reservoirs, and the reservoir protection is closely related to a well completion method. Open hole well completion has higher reservoir protection requirements on the drilling fluids. The existing open hole well completion includes direct open hole well completion, screen pipe well completion, perforated pipe well completion, slotted pipe well completion and other well completion methods. The most important feature of these well completion methods is that the drilling fluids do not run into a casing for perforation after drilling the reservoir, and the drilling fluids are in direct contact with the reservoir, which requires extremely high reservoir protection performance of the drilling fluids. At present, most drilling fluids used in the open hole well completion are the drilling fluids without a solid phase or clay phase, and some of the drilling fluids realizes direct flow-back well completion. In addition, a gel breaking fluid or well completion fluid is injected after running a well completion string to relieve the reservoir damage problem caused by the drilling fluids without a solid phase.

If the drilling fluids without a solid phase or clay phase are directly flowed back, polymers or a filtrate reducer in the drilling fluid will invade pores of an oil well and cannot be degraded, which has a risk of damaging the reservoir. At present, the degradation method of flowing the drilling fluids without a solid phase or clay phase back is usually a gel breaking or delayed gel breaking technology, which can only reduce a viscosity of the polymers in the drilling fluid, but still leave gel breaking residues and filtrate reducer particles. After the viscosity of the drilling fluid is reduced, these gel breaking residues and filtrate reducer particles will still enter the pores of the oil well to damage the reservoir.

Therefore, it is of great significance and application value to develop a drilling fluid that is completely acid-hydrolyzable without any residue, completely avoids the reservoir damage problem caused by the drilling fluid, truly realizes no damage to the reservoir and improves oil and gas production.

A Chinese patent with the publication number: CN114835917A provides a self-deplugging drilling fluid for a carbonate reservoir, with specific components including 100 parts of water, 5-16 parts of composite self-deplugging temporary plugging agent, 2-6 parts of filtrate reducer, 0.1-0.8 parts of tackifier, 0.1-0.5 parts of potential of hydrogen (pH) regulator, 0.1-0.5 parts of waterproof locking agent, 0-7 parts of potassium chloride and 0-230 parts of weighting agent. This patent uses cationic starch, carboxymethyl starch, low-viscosity polyanionic cellulose and low-viscosity carboxymethyl cellulose as the filtrate reducer; and the filtrate reducer disclosed in this patent cannot be dissolved by acid, and the tackifier cannot be degraded by acid or temperature, which means that the drilling fluid for a reservoir disclosed in this patent cannot be completely degraded, and will cause damage to the reservoir.

### SUMMARY

In view of this, an objective of the disclosure is to provide an acid-hydrolyzable residue-free drilling fluid and a preparation method thereof. The acid-hydrolyzable residue-free drilling fluid of the disclosure can be degraded by 100% without any damage to oil and gas reservoirs.

In order to solve the above problem, the specific implementation solution of the disclosure is as follows.

The disclosure provides the acid-hydrolyzable residue-free drilling fluid, including the following components in parts by weight: 100 parts of water, 0.5-1.5 parts of a pH regulator, 0.5-1.0 parts of a flow pattern regulator, 1.0-4.0 parts of a filtrate reducer, 0-10.0 parts of a temporary plugging agent, 1.0-3.0 parts of an inhibitor and 5.0-200.0 parts of a weighting agent.

The pH regulator includes a mixture of sodium citrate, magnesium oxide and sodium carbonate.

The flow pattern regulator includes at least one of polyethylene oxide and polyethyleneimine.

The filtrate reducer includes one or more selected from the group consisting of waxy starch, waxy physically modified starch and waxy chemically modified starch.

In an embodiment, the water is fresh water or seawater.

In an embodiment, based on 100 parts by weight, the pH regulator includes 20-40 parts by weight of sodium citrate, 30-50 parts by weight of magnesium oxide and 30-50 parts by weight of sodium carbonate.

In an embodiment, the waxy starch includes one or more selected from the group consisting of waxy corn starch, waxy potato starch and waxy cassava starch.

The waxy physically modified starch includes one or more selected from the group consisting of pregelatinized waxy corn starch, pregelatinized waxy potato starch and pregelatinized waxy cassava starch.

The waxy chemically modified starch includes one or more selected from the group consisting of carboxymethyl waxy starch, hydroxyethyl waxy starch, hydroxypropyl waxy starch and graft modified waxy starch.

In an embodiment, the temporary plugging agent includes calcium carbonate.

An acid solubility of the calcium carbonate is greater than 99.5%; a particle size D10 of the calcium carbonate is greater than 0.045 millimeters (mm), and a particle size D90 of the calcium carbonate is less than 0.09 mm.

In an embodiment, the inhibitor includes polyamine.

In an embodiment, the weighting agent includes one or more selected from the group consisting of sodium formate, potassium formate and cesium formate.

The disclosure also provides a preparation method of the acid-hydrolyzable residue-free drilling fluid in the above technical solution, which includes the following steps:
sequentially adding the pH regulator, the flow pattern regulator, the filtrate reducer, the temporary plugging agent, the inhibitor and the weighting agent into the water to obtain the acid-hydrolyzable residue-free drilling fluid.

The disclosure provides the acid-hydrolyzable residue-free drilling fluid, including the following components in parts by weight: 100 parts of the water, 0.5-1.5 parts of the pH regulator, 0.5-1.0 parts of the flow pattern regulator, 1.0-4.0 parts of the filtrate reducer, 0-10.0 parts of the temporary plugging agent, 1.0-3.0 parts of the inhibitor and 5.0-200.0 parts of the weighting agent. The pH regulator includes the mixture of the sodium citrate, the magnesium oxide and the sodium carbonate; the flow pattern regulator includes at least one of polyethylene oxide and polyethyleneimine; and the filtrate reducer includes one or more selected from the group consisting of the waxy starch, the waxy physically modified starch and the waxy chemically modified starch.

The acid-hydrolyzable residue-free drilling fluid according to the disclosure fully overcomes shortcomings of residue and non-degradation of drilling fluids without a solid phase or clay phase in the related art. The drilling fluid according to the disclosure can be completely dissolved by an acidic well completion fluid to form a transparent clear solution without suspended matter, realizes 100% degradation, has no damage to the oil and gas reservoirs, and has good environmental protection performance.

The acid-hydrolyzable residue-free drilling fluid according to the disclosure can meet the reservoir protection requirements of open hole well completion, and truly realize no damage to the reservoir. After the acid-hydrolyzable residue-free drilling fluid drills the reservoir, the acidic well completion fluid can be pumped, the acid-hydrolyzable residue-free drilling fluid and mud cakes formed therefrom can be quickly dissolved by acid under a combined action of the acidic well completion fluid and formation temperature, and the fluid after dissolving remains clear and transparent without any suspended residue, thus fundamentally solving the reservoir damage problem of the drilling fluid. The acid-hydrolyzable residue-free drilling fluid according to the disclosure mainly has three types of preparation raw materials: the first type is water-soluble materials, including the sodium citrate and the sodium carbonate of the pH regulator, the water-soluble materials are dissolved in water, and the dissolved aqueous solution will not damage the oil and gas reservoirs. The second type is water-soluble polymers, including the polyethylene oxide and the polyethyleneimine, and these two water-soluble polymers can form a polymer solution with higher viscosity in the aqueous solution, which fully meets needs of a drilling procedure. Within a certain period of time after drilling the reservoir, under the combined action of the acidic well completion fluid and the formation temperature, these two polymers can be completely degraded into small molecular solutions, leaving no damage to the oil and gas reservoirs. The third type is water-insoluble materials, including the magnesium oxide, the calcium carbonate, and one or more selected from the group consisting of the filtrate reducer waxy starch, the waxy physically modified starch and the waxy chemically modified starch. The magnesium oxide and the calcium carbonate can be dissolved by the acidic well completion fluid to generate an aqueous solution. The waxy starch, the waxy physically modified starch and the waxy chemically modified starch can be rapidly hydrolyzed into glucose under acidic conditions and temperature to form a transparent solution, and can also be degraded by 100%. However, ordinary starch and physically and chemically modified starches thereof cannot be rapidly degraded into glucose by acid. Therefore, all raw materials used in the preparation of the acid-hydrolyzable residue-free drilling fluid can be acid-hydrolyzed and degraded, without causing damage to the reservoir.

The acid-hydrolyzable residue-free drilling fluid according to the disclosure has better rheology, filtrate reduction and reservoir protection performance, the mud cakes of the acid-hydrolyzable residue-free drilling fluid can be completely dissolved by 1% methanesulfonic acid solution, the acid solubility reaches 100%, and a turbidity of the methanesulfonic acid solution after dissolving is less than 30 nephelometric turbidity units (NTU). The recovery rate of permeability of the acid-hydrolyzable residue-free drilling fluid without acid treatment is over 96.5%, and the recovery rate of permeability after the acid treatment is 100%. The preparation materials of the acid-hydrolyzable residue-free drilling fluid according to the disclosure are all environment-friendly materials, which provides guarantee for the safety and environmental protection of oil and gas development.

The disclosure provides the preparation method of the acid-hydrolyzable residue-free drilling fluid, which includes the following steps: sequentially adding the pH regulator, the flow pattern regulator, the filtrate reducer, the temporary plugging agent, the inhibitor and the weighting agent into the water to obtain the acid-hydrolyzable residue-free drilling fluid. The preparation method according to the disclosure is simple to operate and has the prospect of industrial application.

### DETAILED DESCRIPTION OF EMBODIMENTS

The disclosure provides an acid-hydrolyzable residue-free drilling fluid, including the following components in parts by weight: 100 parts of water, 0.5-1.5 parts of a pH regulator, 0.5-1.0 parts of a flow pattern regulator, 1.0-4.0 parts of a filtrate reducer, 0-10.0 parts of a temporary plugging agent, 1.0-3.0 parts of an inhibitor and 5.0-200.0 parts of a weighting agent.

The pH regulator includes a mixture of sodium citrate, magnesium oxide and sodium carbonate;

The flow pattern regulator includes at least one of polyethylene oxide and polyethyleneimine.

The filtrate reducer includes one or more selected from the group consisting of waxy starch, waxy physically modified starch and waxy chemically modified starch.

In the disclosure, unless otherwise specified, raw materials used in the disclosure are all preferably commercially available products.

The acid-hydrolyzable residue-free drilling fluid according to the disclosure includes 100 parts by weight of the water. In the disclosure, the water is preferably fresh water or seawater, more preferably fresh water.

Based on the parts by weight of the water, the acid-hydrolyzable residue-free drilling fluid according to the disclosure includes 0.5-1.5 parts by weight of the pH regulator, more preferably 0.8-1.2 parts by weight. In the disclosure, the pH regulator includes preferably the mixture of the sodium citrate, the magnesium oxide and the sodium carbonate. In the disclosure, based on 100 parts by weight of the pH regulator, the pH regulator preferably includes 20-40 parts by weight of the sodium citrate, 30-50 parts by weight of the magnesium oxide and 30-50 parts by weight of the sodium carbonate. In the disclosure, the sodium citrate has chelating and buffering effects, and can chelate with high-valent ions contained in water to ensure other materials to play roles. The magnesium oxide has good acid solubility on one hand, and has a pH buffering effect on the other hand. The sodium carbonate provides basic alkalinity.

Based on the parts by weight of the water, the acid-hydrolyzable residue-free drilling fluid according to the disclosure includes 0.5-1.0 parts by weight of the flow pattern regulator, more preferably 0.6-0.8 parts by weight. In the disclosure, the flow pattern regulator includes preferably at least one of polyethylene oxide and polyethyleneimine. In the disclosure, when the flow pattern regulator includes a mixture of the polyethylene oxide and the polyethyleneimine, a weight ratio of the polyethylene oxide to the polyethyleneimine is preferably 50-70:30-50. In the disclosure, the polyethylene oxide and the polyethyleneimine have good coating inhibition, on one hand, the viscosity and rheology of the drilling fluid can be adjusted, and on the other hand, mud shale encountered in the drilling process can be wrapped to prevent dispersion. The polyethylene oxide has good temperature degradability and may be completely degraded into small molecules in a certain period of time under the action of an underground formation temperature to form a transparent solution without viscosity. Under the combined action of acidic conditions and the formation temperature, the polyethyleneimine may also be degraded into small molecules to form a transparent solution without viscosity.

Based on the parts by weight of water, the acid-hydrolyzable residue-free drilling fluid according to the disclosure includes 1.0-4.0 parts by weight of filtrate reducer, more preferably 2.0-3.0 parts by weight. In the disclosure, the filtrate reducer includes one or more selected from the group consisting of waxy starch, waxy physically modified starch and waxy chemically modified starch. In the disclosure, the waxy starch includes preferably one or more selected from the group consisting of waxy corn starch, waxy potato starch and waxy cassava starch. In the disclosure, the waxy corn starch, waxy potato starch and waxy cassava starch may be compounded in any proportion. In the disclosure, the waxy physically modified starch includes preferably one or more selected from the group consisting of pregelatinized waxy corn starch, pregelatinized waxy potato starch and pregelatinized waxy cassava starch. In the disclosure, the pregelatinized waxy corn starch, pregelatinized waxy potato starch and pregelatinized waxy cassava starch may be compounded in any proportion. In the disclosure, the waxy chemically modified starch includes preferably one or more selected from the group consisting of carboxymethyl waxy starch, hydroxyethyl waxy starch, hydroxypropyl waxy starch and graft modified waxy starch. In the disclosure, the carboxymethyl waxy starch, hydroxyethyl waxy starch, hydroxypropyl waxy starch and graft modified waxy starch may be compounded in any proportion. In the disclosure, a production process of the modified starch is not limited, and may be a production process in the related art. In the disclosure, a raw material of the waxy chemically modified starch is preferably one of the waxy corn starch, waxy potato starch and waxy cassava starch or obtained by compounding the above in any proportion.

In the disclosure, an amylopectin content in the waxy corn starch, waxy potato starch and waxy cassava starch is preferably 100%. In the disclosure, the waxy starch, waxy physically modified starch and waxy chemically modified starch can be rapidly hydrolyzed into glucose, and the solution after hydrolyzing is clear and transparent without suspension residue. However, ordinary starch and physically and chemically modified starches thereof cannot be quickly acid-hydrolyzed into glucose at the formation temperature of 60-140 degrees Celsius (° C.).

Based on the parts by weight of the water, the acid-hydrolyzable residue-free drilling fluid according to the disclosure includes 0-10.0 parts by weight of the temporary plugging agent. In the disclosure, the temporary plugging agent is preferably calcium carbonate. In the disclosure, an acid solubility of the calcium carbonate is preferably greater than 99.5%; a particle size D10 of the calcium carbonate is preferably greater than 0.045 mm and a particle size D90 of the calcium carbonate is less than 0.09 mm. The high purity of calcium carbonate ensures that it can be completely dissolved by acid, and the particle size of calcium carbonate is controlled within a very small range to improve a temporary plugging performance on one hand, and to ensure that the calcium carbonate used is all large particles to prevent the calcium carbonate from invading into a deep stratum on the other hand.

Based on the parts by weight of the water, the acid-hydrolyzable residue-free drilling fluid according to the disclosure includes 1.0-3.0 parts by weight of the inhibitor, more preferably 1.2-2.5 parts by weight. In the disclosure, the inhibitor is preferably polyamine. In the disclosure, the inhibitor polyamine is soluble in water, and is easy to form an aqueous solution, which will not damage the oil and gas reservoirs. In the disclosure, the type of the polyurethane is not limited, and is commercially available.

The acid-hydrolyzable residue-free drilling fluid according to the disclosure includes 5.0-200.0 parts by weight of the weighting agent. In the disclosure, the weighting agent includes one or more selected from the group consisting of sodium formate, potassium formate and cesium formate. In the disclosure, the weighting agent is soluble in water, and is easy to form an aqueous solution, which will not damage the oil and gas reservoirs. In the disclosure, the type of the weighting agent is not limited, and is commercially available.

The disclosure also provides a preparation method of the acid-hydrolyzable residue-free drilling fluid, which includes the following steps:
sequentially adding the pH regulator, the flow pattern regulator, the filtrate reducer, the temporary plugging agent, the inhibitor and the weighting agent into the water to obtain the acid-hydrolyzable residue-free drilling fluid.

In the disclosure, the pH regulator, flow pattern regulator, filtrate reducer, temporary plugging agent, inhibitor and weighting agent are all preferably added under the condition of stirring, and a stirring rate is preferably 3000-10000 revolutions per minute (r/min). In the disclosure, the whole preparation process preferably adopts the same stirring rate.

In the disclosure, after the pH regulator is added, it is preferable to stir for 10 minutes (min).

In the disclosure, after the flow pattern regulator is added, it is preferable to stir for 30 min.

In the disclosure, after the filtrate reducer is added, it is preferably to stir for 30 min.

In the disclosure, after the temporary plugging agent is added, it is preferable to stir for 20 min.

In the disclosure, after the inhibitor and weighting agent are preferably added at the same time, it is preferable to stir for 40-60 min to obtain the acid-hydrolyzable residue-free drilling fluid.

The technical solution of the disclosure will be further explained by specific embodiments. Those skilled in the art should understand that the following embodiments are only part of the embodiments of the disclosure, are used to help understand the disclosure and should not be regarded as specific limitations to the disclosure.

### Embodiment 1

An acid-hydrolyzable residue-free drilling fluid includes the following preparation steps: adding 100 parts by weight of fresh water into a container, turning on a stirrer at a rotating speed of 3000 r/min, and adding 1.5 parts by weight of pH regulator into the fresh water and stirring for 10 min; then slowly adding 1.0 part by weight of flow pattern regulator polyethylene oxide, followed by continuously stirring for 30 min; then slowly adding 1.0 part by weight of filtrate reducer waxy corn starch, and continuously stirring for 30 min; then adding 3.0 parts by weight of inhibitor polyamine and 200.0 parts by weight of weighting agent cesium formate, and continuously stirring for 40 min to obtain the acid-hydrolyzable residue-free drilling fluid.

Based on 100 parts by weight, the pH regulator includes 20 parts by weight of sodium citrate, 50 parts by weight of magnesium oxide and 30 parts by weight of sodium carbonate.

### Embodiment 2

An acid-hydrolyzable residue-free drilling fluid includes the following preparation steps: adding 100 parts by weight of seawater into a container, turning on a stirrer at a rotating speed of 10000r/min, adding 0.5 parts by weight of pH regulator into the seawater and stirring for 10 min; then slowly adding 0.5 parts by weight of flow pattern regulator polyethyleneimine, and continuously stirring for 30 min; then slowly adding 1.0 part by weight of filtrate reducer wax pregelatinized potato starch, and continuously stirring for 30 min; then adding 10.0 parts by weight of temporary plugging agent calcium carbonate, and continuously stirring for 20 min; then adding 1.0 part by weight of inhibitor polyamine and 5.0 parts by weight of weighting agent sodium formate, and continuously stirring for 40 min to obtain the acid-hydrolyzable residue-free drilling fluid.

Based on 100 parts by weight, the pH regulator includes 40 parts by weight of sodium citrate, 30 parts by weight of magnesium oxide and 30 parts by weight of sodium carbonate.

### Embodiment 3

An acid-hydrolyzable residue-free drilling fluid includes the following preparation steps: adding 100 parts by weight of fresh water into a container, turning on a stirrer at a rotating speed of 6000 r/min, and adding 1.0 part by weight of pH regulator into the fresh water, and stirring for 10 min; then slowly adding 0.8 part by weight of flow pattern regulator, and continuously stirring for 30 min; then slowly adding 3.0 parts by weight of filtrate reducer waxy chemically modified starch, and continuously stirring for 30 min; then adding 5.0 parts by weight of temporary plugging agent calcium carbonate, and continuously stirring for 20 min; then adding 1.2 parts by weight of inhibitor polyamine and 100.0 parts by weight of weighting agent potassium formate, and continuously stirring for 40 min to obtain the acid-hydrolyzable residue-free drilling fluid.

Based on 100 parts by weight, the pH regulator includes 30 parts by weight of sodium citrate, 30 parts by weight of magnesium oxide and 40 parts by weight of sodium carbonate;

Based on 100 parts by weight, the flow pattern regulator includes 70 parts by weight of polyethylene oxide and 30 parts by weight of polyethyleneimine.

An acid solubility of the calcium carbonate is greater than 99.5%, and a particle size is measured by a wet laser particle size analyzer, with D10 being greater than 0.045 mm and D90 being less than 0.09 mm.

The waxy chemically modified starch is carboxymethyl waxy starch; a production process of the waxy chemically modified starch may be the existing published production process, and the raw material of the waxy chemically modified starch adopts waxy cassava starch.

### Embodiment 4

An acid-hydrolyzable residue-free drilling fluid includes the following preparation steps: adding 100 parts by weight of seawater into a container, turning on a stirrer at a rotating speed of 8000 r/min, adding 0.6 part by weight of pH regulator into the seawater, and stirring for 10 min; then slowly adding 0.7 parts by weight of flow pattern regulator, and continuously stirring for 30 min; then slowly adding 2.0 parts by weight of filtrate reducer, and continuously stirring for 30 min; then adding 8.0 parts by weight of temporary plugging agent calcium carbonate, and continuously stirring for 20 min; then adding 2.0 parts by weight of inhibitor polyamine and 50.0 parts by weight of weighting agent, and continuously stirring for 40 min to obtain the acid-hydrolyzable residue-free drilling fluid.

Based on 100 parts by weight, the pH regulator includes 20 parts by weight of sodium citrate, 30 parts by weight of magnesium oxide and 50 parts by weight of sodium carbonate.

Based on 100 parts by weight, the flow pattern regulator includes 50 parts by weight of polyethylene oxide and 50 parts by weight of polyethyleneimine.

Based on 100 parts by weight, the filtrate reducer includes 40 parts by weight of waxy starch and 60 parts by weight of waxy physically modified starch; based on 100 parts by weight, the waxy starch includes 30 parts by weight of waxy corn starch, 50 parts by weight of waxy potato starch and 20 parts by weight of waxy cassava starch. Based on 100 parts by weight, the waxy physically modified starch includes 50 parts by weight of pregelatinized waxy corn starch, 20 parts by weight of pregelatinized waxy potato starch and 30 parts by weight of pregelatinized waxy cassava starch.

An acid solubility of the calcium carbonate is greater than 99.5%, and a particle size is measured by a wet laser particle size analyzer, with D10 being greater than 0.045 mm and D90 being less than 0.09 mm.

Based on 100 parts by weight, the weighting agent includes 30 parts by weight of sodium formate and 70 parts by weight of potassium formate.

### Embodiment 5

An acid-hydrolyzable residue-free drilling fluid includes the following preparation steps: adding 100 parts by weight of seawater into a container, turning on a stirrer at a rotating speed of 4000 r/min, adding 1.2 parts by weight of pH regulator into the seawater and stirring for 10 min; then slowly adding 0.9 parts by weight of flow pattern regulator, and continuously stirring for 30 min; then slowly adding 2.5 parts by weight of filtrate reducer, and continuously stirring for 30 min; then adding 4.0 parts by weight of temporary plugging agent calcium carbonate, and continuously stirring for 20 min; then adding 2.5 parts by weight of inhibitor polyamine and 150.0 parts by weight of weighting agent, and continuously stirring for 40 min to obtain the acid-hydrolyzable residue-free drilling fluid.

Based on 100 parts by weight, the pH regulator includes 20 parts by weight of sodium citrate, 40 parts by weight of magnesium oxide and 40 parts by weight of sodium carbonate.

Based on 100 parts by weight, the flow pattern regulator includes 60 parts by weight of polyethylene oxide and 40 parts by weight of polyethyleneimine.

Based on 100 parts by weight, the filtrate reducer includes 20 parts by weight of waxy starch, 30 parts by weight of waxy physically modified starch and 50 parts by weight of waxy chemically modified starch; the waxy starch is waxy potato starch; the waxy physically modified starch is pregelatinized waxy cassava starch; the waxy chemically modified starch is hydroxypropyl waxy starch.

An acid solubility of the calcium carbonate is greater than 99.5%, and a particle size is measured by a wet laser particle size analyzer, with D10 being greater than 0.045 mm and D90 being less than 0.09 mm.

Based on 100 parts by weight, the weighting agent includes 60 parts by weight of potassium formate and 40 parts by weight of cesium formate.

### Comparative Embodiment 1

The filtrate reducer in Embodiment 2 is changed to ordinary corn starch, and a drilling fluid without a solid phase is obtained.

### Comparative Embodiment 2

The filtrate reducer in Embodiment 2 is changed to pregelatinized common cassava starch, and a drilling fluid without a clay phase is obtained.

The drilling fluids prepared in the above Embodiments 1-5 and Comparative Embodiments 1-2 are tested according to GB/T16783.1-2014 Field Testing of Drilling Fluids in Petroleum and Natural Gas Industry Part 1: Water-Based Drilling Fluids, and the test results are shown in Table 1.

TABLE 1
Test results of drilling fluids prepared in Embodiments
1-5 and Comparative Embodiments 1-2.

| | T, | | PV, | YP, | | API, | HFL-1, | HFL-2, |
|---|---|---|---|---|---|---|---|---|
| Sample | ° C. | State | mPa · s | Pa | Φ3 | mL | % | % |
| Embodiment 1 | 140 | after aging | 25 | 9 | 7 | 5.8 | 98.45 | 100.05 |
| | | for 24 h | | | | | | |
| Embodiment 2 | 100 | after aging | 20 | 6 | 4 | 3.6 | 97.24 | 100.00 |
| | | for 24 h | | | | | | |
| Embodiment 3 | 120 | after aging | 23 | 7 | 6 | 4.4 | 97.47 | 100.14 |
| | | for 24 h | | | | | | |
| Embodiment 4 | 120 | after aging | 26 | 8 | 7 | 4.2 | 96.85 | 100.84 |
| | | for 24 h | | | | | | |
| Embodiment 5 | 80 | after aging | 24 | 9 | 8 | 4.0 | 96.50 | 100.28 |
| | | for 24 h | | | | | | |
| Comparative | 100 | after aging | 19 | 6 | 5 | 3.8 | 70.82 | 80.35 |
| embodiment 1 | | for 24 h | | | | | | |
| Comparative | 100 | after aging | 20 | 10 | 8 | 4.2 | 68.15 | 78.17 |
| embodiment 2 | | for 24 h | | | | | | |

Note:
T: aging temperature of drilling fluid, ° C.; PV: plastic viscosity of drilling fluid, millipascal-second (mPa · s); YP: dynamic shear force of drilling fluid, pascal (Pa); Φ3: 3-revolution reading of six-speed rotary viscometer, dimensionless; API: water loss in drilling fluid under pressure [0.7 megapascal (MPa), 30 min], mL; HFL-1: permeability recovery rate after the drilling fluid directly pollutes the core, %; HFL-2: permeability recovery rate after the drilling fluid pollutes the core and then the core is polluted with 1% methanesulfonic acid, %.

The drilling fluids prepared in Embodiments 1-5 and Comparative Embodiments 1-2 of the disclosure all have better rheological properties and filtrate reduction. After the drilling fluids in Embodiments 1 to 5 of the disclosure directly pollute the core, the permeability recovery rate reached greater than 96.5%, and after the core is polluted again by a methanesulfonic acid solution, the permeability recovery rate could be recovered to 100%, even higher, exceeding 100% since the acid solution corroded inherent pores in the core. The direct flow-back permeability recovery rates HFL-1 in Comparative Embodiments 1 and 2 are only 70.82% and 68.15%. Even after treatment with methanesulfonic acid, the permeability recovery rates HFL-2 are slightly improved, and only about 80.35% and 78.17%. Comparative Embodiments 1 and 2 used the ordinary starch, which could not be completely acid-hydrolyzed, and there are residual starch particles, indicating that the starch particles not acid-hydrolyzed caused damage to the core.

Mud cakes obtained from the drilling fluids prepared in Embodiments 1-5 and Comparative Embodiments 1-2 are soaked in 1% weight fraction of methanesulfonic acid solution, and after standing at testing temperature for a certain period of time, the turbidity and pH value of the methanesulfonic acid solution are tested, the solution is filtered and then dried to obtain residue, and the acid solubility of the mud cakes is calculated. The test results are shown in Table 2.

TABLE 2
Test results of mud cakes obtained from drilling fluids
prepared in Embodiments and Comparative Embodiments
after soaking in methanesulfonic acid solution.

| | Testing | Standing | | | |
|---|---|---|---|---|---|
| | temperature | time, | pH | ZD, | SRL, |
| Sample | T, ° C. | hour | value | NTU | % |
| 1% methanesulfonic | — | 6 h | 1.24 | 5.45 | — |
| acid | | | | | |
| Embodiment1 | 100 | 6 h | 2.32 | 18.66 | 100.0 |
| Embodiment2 | 100 | 6 h | 1.82 | 15.47 | 100.0 |
| Embodiment3 | 100 | 6 h | 1.73 | 13.95 | 100.0 |
| Embodiment4 | 100 | 6 h | 1.54 | 17.64 | 100.0 |
| Embodiment5 | 100 | 6 h | 1.86 | 10.75 | 100.0 |
| Comparative | 100 | 6 h | 1.33 | 108.41 | 64.25 |
| embodiment1 | | | | | |
| Comparative | 100 | 6 h | 1.48 | 145.63 | 58.41 |
| embodiment2 | | | | | |
| Embodiment1 | 130 | 3 h | 2.56 | 12.54 | 100.0 |
| Embodiment2 | 130 | 3 h | 1.98 | 11.23 | 100.0 |
| Embodiment3 | 130 | 3 h | 1.79 | 10.78 | 100.0 |
| Embodiment4 | 130 | 3 h | 1.82 | 9.82 | 100.0 |
| Embodiment5 | 130 | 3 h | 1.64 | 10.08 | 100.0 |
| Comparative | 130 | 3 h | 1.35 | 97.64 | 68.35 |
| embodiment1 | | | | | |
| Comparative | 130 | 3 h | 1.42 | 116.31 | 60.28 |
| embodiment2 | | | | | |

Note:
pH value: pH value of mud cakes after soaking in methylsulfonic acid solution; ZD: turbidity of mud cakes after soaking in methylsulfonic acid solution, with the dimension being NTU; SRL: acid solubility of mud cakes after soaking in methylsulfonic acid solution, with 1% methylsulfonic acid being a blank comparative embodiment, that is, the test data of 1% methylsulfonic acid solution per se without soaking the mud cakes.

After the mud cakes of the drilling fluids are soaked in the methanesulfonic acid solution, and stood at the high temperatures of 100° C. and 130° C., the mud cakes of Embodiments 1 to 5 of the disclosure are all dissolved by the methanesulfonic acid, and the turbidity of the methanesulfonic acid solution after dissolving is less than 30 NTU, which met the reservoir protection standard of a well completion fluid, indicating that it would not damage the reservoir, and the acid solubility of the mud cakes reached 100%, realizing real no residue. However, after the mud cakes of Comparative Embodiments 1 and 2 are placed in the methanesulfonic acid solution, the turbidity of the methanesulfonic acid solution reached greater than 100 NTU, the solution is relatively turbid, the mud cakes are flocculent precipitation, which would damage the reservoir and the acid solubility of the mud cakes is only about 60%. This flocculent precipitation is caused by the starch filtrate reducer in the mud cakes, indicating that the starch is not acid-hydrolyzed.

The foregoing is merely preferred embodiments of the disclosure, and does not limit the disclosure in any form. It should be pointed out that for those ordinary skilled in the art, several improvements and embellishments can be made without departing from the principle of the disclosure, and these improvements and embellishments should also be regarded as the protection scope of the disclosure.

What is claimed is:

1. An acid-hydrolyzable residue-free drilling fluid, comprising the following components in parts by weight:
100 parts of water, 0.5-1.5 parts of a potential of hydrogen (pH) regulator, 0.5-1.0 parts of a flow pattern regulator, 1.0-4.0 parts of a filtrate reducer, 0-10.0 parts of a temporary plugging agent, 1.0-3.0 parts of an inhibitor and 5.0-200.0 parts of a weighting agent;
wherein the pH regulator comprises a mixture of sodium citrate, magnesium oxide and sodium carbonate;
wherein the flow pattern regulator comprises at least one of polyethylene oxide and polyethyleneimine; and
wherein the filtrate reducer comprises one or more selected from the group consisting of waxy starch, waxy physically modified starch and waxy chemically modified starch.

2. The acid-hydrolyzable residue-free drilling fluid according to claim 1, wherein the water is fresh water or seawater.

3. The acid-hydrolyzable residue-free drilling fluid according to claim 1, wherein based on 100 parts by weight, the pH regulator comprises: 20-40 parts by weight of the sodium citrate, 30-50 parts by weight of the magnesium oxide and 30-50 parts by weight of the sodium carbonate.

4. The acid-hydrolyzable residue-free drilling fluid according to claim 1, wherein the waxy starch comprises one or more selected from the group consisting of waxy corn starch, waxy potato starch and waxy cassava starch;
the waxy physically modified starch comprises one or more selected from the group consisting of pregelatinized waxy corn starch, pregelatinized waxy potato starch and pregelatinized waxy cassava starch; and
the waxy chemically modified starch comprises one or more selected from the group consisting of carboxymethyl waxy starch, hydroxyethyl waxy starch, hydroxypropyl waxy starch and graft modified waxy starch.

5. The acid-hydrolyzable residue-free drilling fluid according to claim 1, wherein the temporary plugging agent comprises calcium carbonate; and
an acid solubility of the calcium carbonate is greater than 99.5%; a particle size D10 of the calcium carbonate is greater than 0.045 millimeters (mm), and a particle size D90 of the calcium carbonate is less than 0.09 mm.

6. The acid-hydrolyzable residue-free drilling fluid according to claim 1, wherein the inhibitor is polyamine.

7. The acid-hydrolyzable residue-free drilling fluid according to claim 1, wherein the weighting agent comprises one or more selected from the group consisting of sodium formate, potassium formate and cesium formate.

8. A preparation method of the acid-hydrolyzable residue-free drilling fluid according to claim 1, comprising the following steps:
sequentially adding the pH regulator, the flow pattern regulator, the filtrate reducer, the temporary plugging agent, the inhibitor and the weighting agent into the water to obtain the acid-hydrolyzable residue-free drilling fluid.
